(19) United States
(12) Patent Application Publication
(10) Pub. No.: US 2006/0068364 A1
(43) Pub. Date: Mar. 30, 2006

(54) Methods and devices for the prevention and treatment of gingival recession

(76) Inventor: James Timothy Struck, Chicago, IL (US)

Correspondence Address: JAMES T. STRUCK, APT. 206, 2000 W. MORSE AVE., CHICAGO, IL, 60645, US

(21) Appl. No.: 11/234,078

(22) Filed: Sep. 23, 2005

Related U.S. Application Data
(60) Provisional application No. 60/614,273, filed on Sep. 29, 2004.

(51) Int. Cl. A61C 5/00

(52) U.S. Cl. 433/215

(57) ABSTRACT

According to the Merck Manual of Medical Information (2003, 2^{nd} Home Edition), “Recession usually occurs in response to overaggressive brushing but can also result from injury or as the natural progression of thin, delicate gum tissue.” (p. 622) Grafting or other surgeries involve complications, pain, bleeding, possible infections and missed work. This invention involves the use of gauze to remove plaque and other pathogens from the crown or tooth surfaces. This invention only involves possible use of saliva, hydroxyl ions as a base, and cold water depending on the needs of the specific gingival issue. If the gums are acidic, the gauze could include hydroxyl ions. If the gums are infected with campylobacter germs, Ebola, HIV, influenza or other exotic pathogens, cold water can decrease the growth of these pathogens. Saliva can fight against candida, fungus, polio, colds, herpes, and HIV. Pressure of the gauze against the gingival and tooth interface could increase bonding and healing between the gum and the tooth. In addition, saliva can be collected and placed with the gauze in a container during a person's growth. The person's saliva over a life span can be used to study the gum recession and saliva in a patient. One possible use of this invention is to look at DNA evidence used in criminal cases compared against the samples taken from the gums.

### BACKGROUND OF THE INVENTION OR ABSTRACT

1. Field of Invention

Gingival recession or gum recession is a major problem in the health of people and animals. Regularly, surgeries involving grafting tissue from the top of the mouth or somewhere else to be placed on the gum line occur. These surgeries involve complications, pain, bleeding, possible infections and missed work. According to the Merck Manual of Medical Information (2003, 2^{nd} Home Edition), “Recession usually occurs in response to overaggressive brushing, but can also result from injury or as the natural progression of thin, delicate gum tissue. Most people have some slight recession.” (p. 622)

As an alternative or in addition to brushing, this invention involves the use of gauze to remove or limit plaque and other pathogens from the crown or tooth surfaces. There are other inventions which use gauze to clean, polish and remineralize the tooth, but this invention only involves possible use of saliva, hydroxyl ions as a base, and cold water depending on the needs of the specific gingival issue. If the gums are acidic, the gauze could have hydroxyl ions added. If the gums are infected with campylobacter germs, diptheria germs, protozoa like malaria, ebola, HIV, typhus or other exotic pathogens, cold water can decrease the growth of these pathogens. A person or animal's saliva can fight against candida, fungus, polio, colds, herpes, and HIV (according to the National Center for Dental and Craniofacial Research Web Site).

Pressure of the gauze against the gingival and tooth interface could increase bonding and healing between the gum and the tooth. In addition, saliva can be collected and placed with the gauze in a container during the growth of a person. The person's saliva over a life span can be used to study the gum recession in a patient.

It should be made clear that there are very few inventions which discuss just gingival recession. Most of the inventions in this field deal with periodontal disease. Periodontal disease is a larger field including gingivitis (inflammation of the gums (gingiva)), periodontitis (severe form of gingivitis in which there is inflammation extending to the supporting structures of the tooth), trench mouth (painful, noncontagious infection of the gums). This invention limits its claims to the function of preventing and treating gingival recession and the gum saliva preservation issue.

2. Prior Art

The initial invention back in 1990 was to put a shield on the tooth in the form of an impression plate to stop plaque, carbohydrates and bacteria from touching the tooth. Since this was disclosed over one year ago, it is no longer something I can claim a patent on. The different inventions I looked at, or was somewhat aware of, to understand what would be reasonable to claim included inventions relating to oral swabs (as I was considering an oral paintbrush healing system), delivery agent systems, crowns, tooth caps, veneers, sealants, tooth strips, full denture inventions similar to my original idea, tooth shields, trays, medication systems, oral bandages, oral patches, and remineralizing agent systems. Oral healing systems, pastes, extraction healing, paintbrush systems, and oral care chemistry systems were also glanced at. I only reviewed the abstracts for most of these. What follows is a discussion of relevant inventions for the area I decided to focus on.

U.S. Pat. No. 5,938,435 discusses a shield with fluoride, teeth whitening agents, anaesthetic, anticoagulant, antibiotic and mentions gauze and wax. The rule I was taught from Patent it Yourself by David Pressman, is that “If each and every one of the following claims is met, infringement occurs. If not all of the elements are met, there is no infringement.” (p. 15/11, published April 2004, Nolo, 10^{th} edition) My invention includes far fewer elements and also focuses on gum recession.

U.S. Pat. No. 5,445,825 by Phoebe Copelan and James Copelan discusses a gauze impregnated with tooth cleaner and expectorants. There is also a remineralizing agent. This invention is also involved with many more issues than limiting gingival recession.

Patent application number 20040127421 by Sohail Malik mentions peptides for maintaining the skin and increasing fibronectin. This has a different focus and different elements.

U.S. Pat. No. 5,648,399 focuses on a liquid polymer composition and method of use for the release of liquid methacrylic. These are very different elements than mine. U.S. Pat. No. 5,438,076, U.S. Pat. No. 5,160,737 and U.S. Pat. No. 5,639,795 are similar. These have a different method of use and different function.

Patent application 20050037966 discusses cleansing wounds. This is a different focus than preventing the recession of the gums. The gauze is only mentioned with regard to cleaning wounds.

Patent application 20040224387 gives a gauze wound protocol. This is a different function and structure than my invention. This deals with polynucleotides, polypeptides, and keratinocyte growth factors as a tool in healing. These are different elements and claims than my invention.

Patent application 20030202947 by Dennis Szymaitis discusses a sponge pocket regeneration composition with antibacterial compounds, peroxide, and alum. This invention focuses on regeneration not on pressuring the gums against the tooth to promote reconnection. The procedure involves different elements and steps.

Patent application 20030194380 involves a regeneration composition to inject in pockets which has different elements than decreasing pathogen counts, decreasing acidity, and applying saliva with gauze

Patent application 20030186904 from Steven Ruben focuses on cleansing wounds not on cleaning the crown of the tooth so that the gums do not recede.

My search involved the terms “gums recession, gum recession, gingiva recession, gingival recession and gauze” with an all fields search. I did not look at the “periodontal disease” inventions simply because they involve more claims than my invention. I am trying to decrease the amount of recession through a method and a type of tool. I do not claim to have any effect on inflammation or inflammation to the root. Again, my claim only extends to gum recession, so I did not look at all the inventions which claim more than my claim as I was following the infringement rule above.

U.S. Pat. Nos. 5,766,011 and 6,846,182 by Sibner concern bleaching teeth. That is not my concern.

Again, I may have mistakenly violated the intellectual property of someone without knowing it. Any violation or error in citation style is unintentional. I apologize for any mistake with regard to citation style, because I do believe that not citing people's work has bad psychological effects.

### SPECIFICATIONS OF HOW TO MAKE AND USE THIS METHOD AND DEVICE FOR PREVENTING AND TREATING GINGIVAL RECESSION

Gauze is commonly available in most drug stores and grocery stores. It can be obtained in a long strip or in small or large pieces. The types commonly available have a variety of pore sizes and fiber sizes. Teeth come in a variety of sizes from incisors, canines, molars, cuspids or animal teeth like walrus, ostrich, seals, fish, bear, tiger or panda.

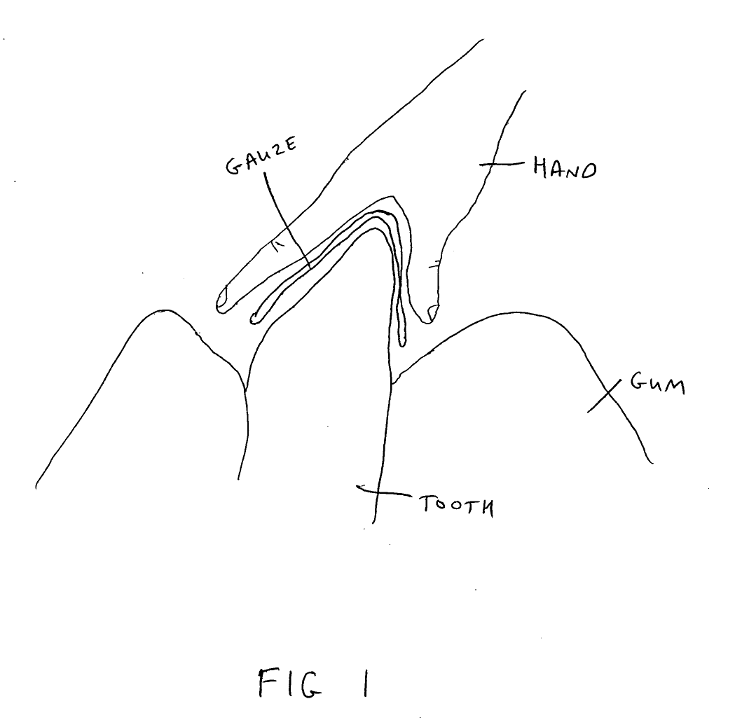

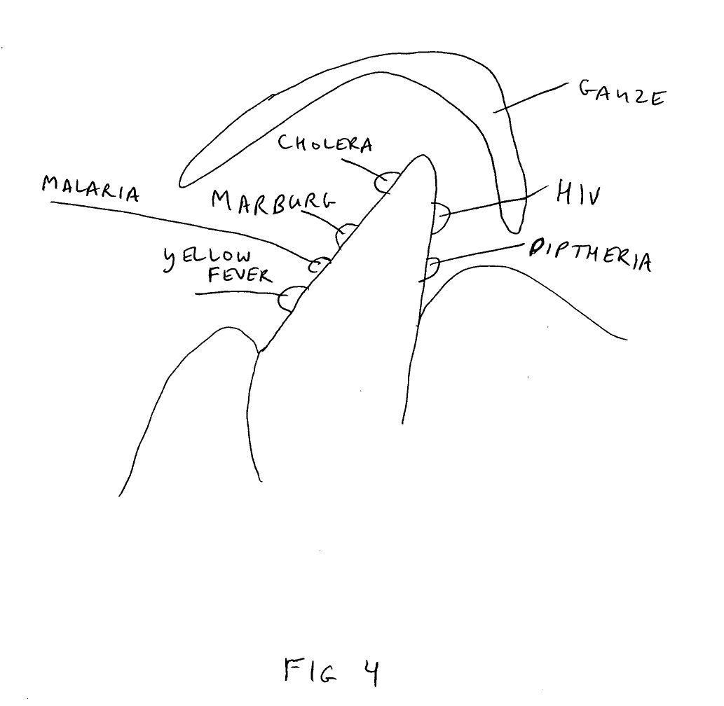

The person intending to use this invention could cut a piece of gauze appropriate to the tooth of the human, creature or animal being treated. The person would use a few fingers to wipe the top part of the tooth. (See FIG. 1) This procedure would occur so that infections like malaria, plague, HIV, yellow fever, dengue, typhus or cholera are removed from the top of the tooth. (See FIG. 4) With the removal of these kind of bacteria, viruses, and protozoa from the crown of the tooth, there would be less need to brush aggressively and contribute to gingival recession.

Cold water is easily obtained from a faucet to decrease the amount of growth of pathogens in the area of the gums. Cold water can also be distributed in packets cooled with certain chemicals. Pathogens play a significant role possibly in contributing to the recession of the gums. Some germs can cause the gums to recede possibly. The basis of this concept is antigen, tissue and antibody response. Antibodies or tissue sometimes avoid antigens and sometimes go near antigens. Pathogens can also destroy tissue as well and cause recession.

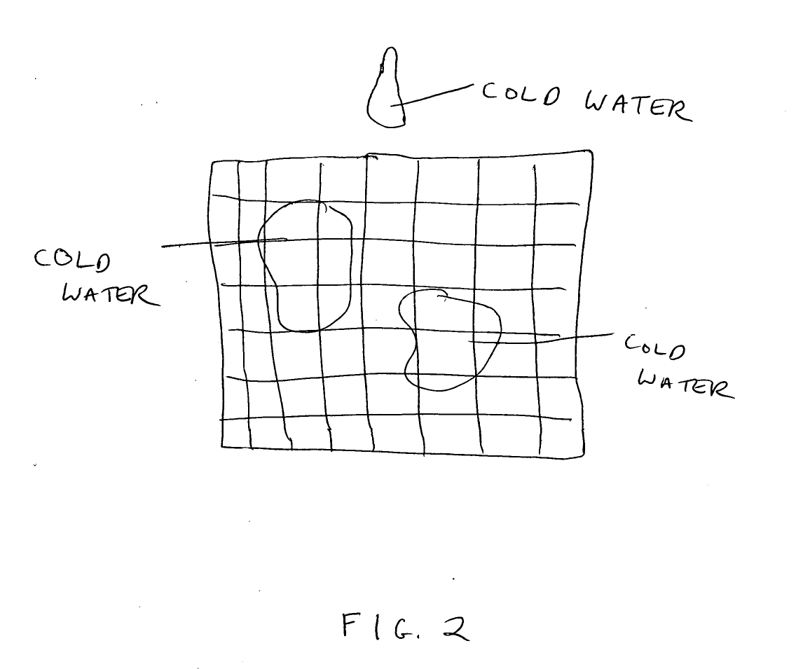

This idea of using cold water to decrease the amount of pathogens in the mouth was contributed by the author Wayne Biddle, A Field Guide to Germs, New York: Anchor Books, 1996. In his discussion of campylobacter, he discusses how campylobacter thrives at the “body temperatures of their warm-blooded hosts.” (p. 32) There is less need then for overaggressive brushing, which could increase gingival recession, when the gauze is attached to cold water to decrease pathogen growth rates. This is shown in FIG. 2.

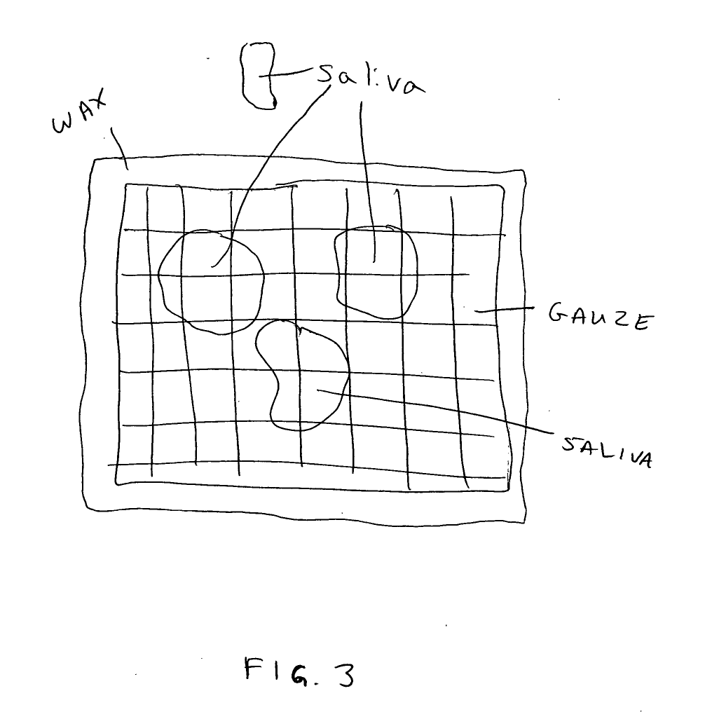

Saliva is easily obtained from the mouth of the organism. Of course, in cases of dry mouth, the saliva will be harder to extract or find. From the web site of the National Institute of Dental Craniofacial Research, saliva is said to fight herpes, cold virus, polio virus, fungus, bacteria, candida albicans, and HIV. This web site of this NIH institute was accessed in early 2005; I do not recall the exact date. The saliva can be attached to the gauze and can fight infections. There is less need for over aggressive brushing when the saliva in the gauze is fighting infections in the tooth. This is shown in FIG. 3.

The wax is also shown in FIG. 3. The wax is provided to hold the gauze in place and secure it there.

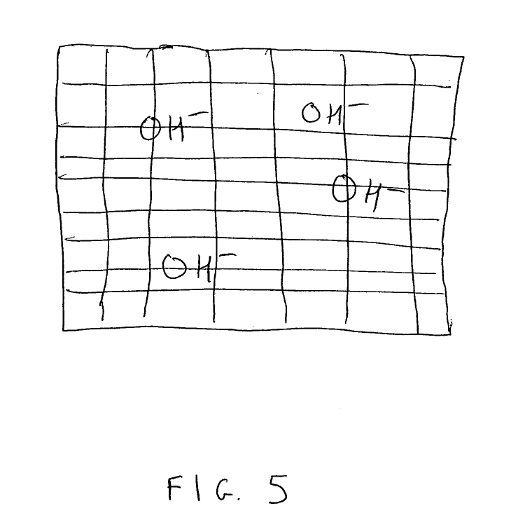

Hydroxyl ions are obtained from most drug stores or chemical stores. The hydroxyl ions would be dropped onto the gauze into the fibers of the gauze. With the hydroxyl ions, the acid in the tooth or gums would combine with the hydroxyl ions and form water. This would decrease the acidity of the mouth which would decrease the amount of plaque in the mouth. This would again provide less need for overaggressive brushing which contributes to gingival recession. This is shown in FIG. 5.

Under 35 USC 287 C, medical procedures can be performed without liability by health care providers. Part of this patent does protect this kind of medical procedure. For example, the process of pressing the gauze against the tooth and gum to increase the connection of the gum with the tooth is a medical procedure.

Pressure of the gauze against the tooth and gum would increase the number of connections between tissues and chemicals in the tooth and the gums. Of course, in some cases, the pressure would be very ill advised. Pathogens would be trapped between the tooth and the gums. We would not want people to pressure the gums and teeth in cases in which the area of recession is not clean or filled with pathogens.

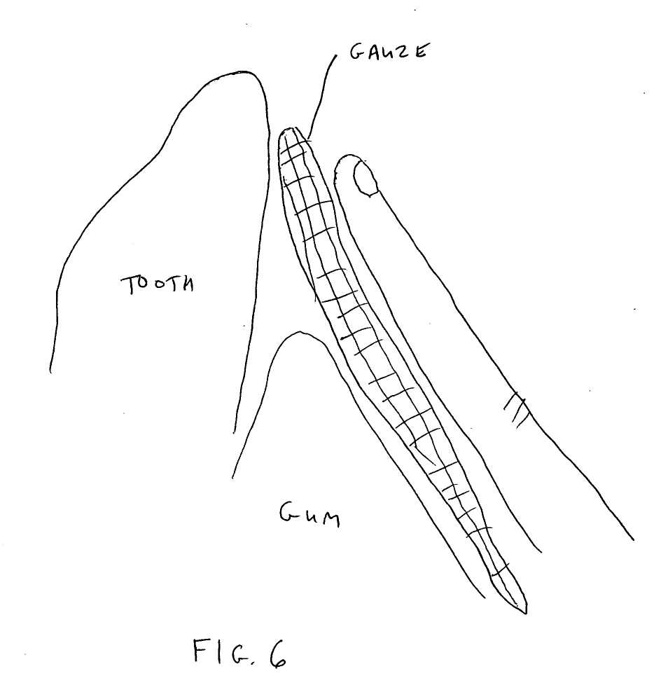

There would have to be training between the dentist, pharmacist, nurse, health care provider and the patient about how to use the gauze and how to pressure the gauze and gums. I am using the patent to discuss this innovation to decrease gingival recession, and possibly get credit of some sort even though health care providers can perform this procedure without liability according to the just mentioned statute. I may have misunderstood the statute. This is shown in FIG. 6.

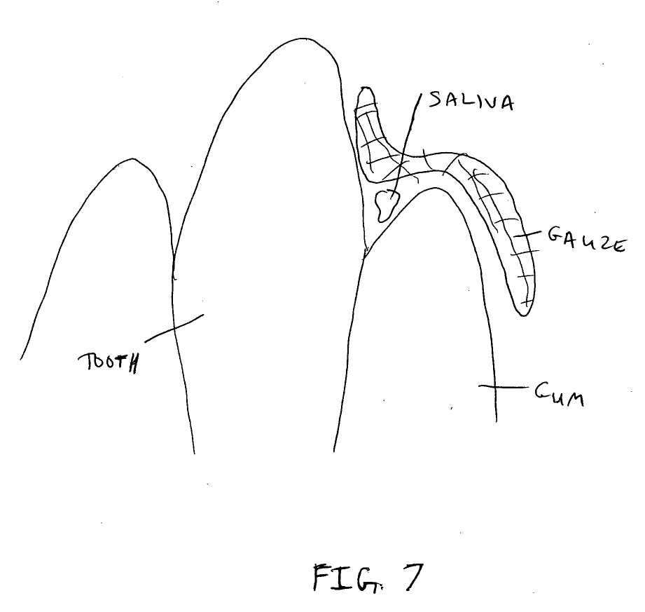

In FIG. 7, the gauze can capture a piece of saliva from the area near the gum and the tooth. The fibers and pores of the saliva capture the saliva from the area between the gum and the tooth.

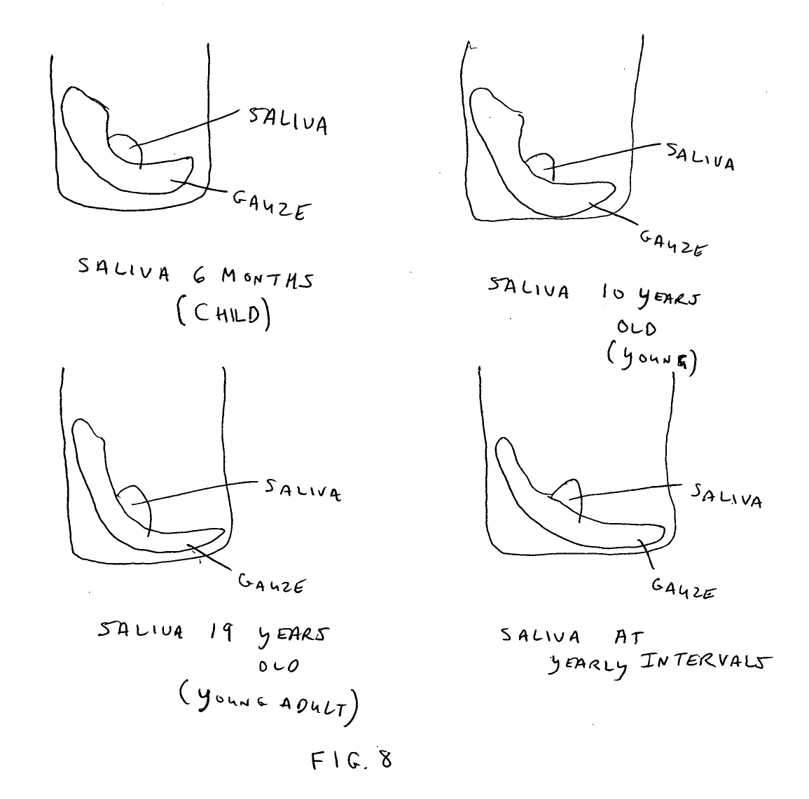

In FIG. 8, the gauze is placed into containers at intervals throughout the life of the organism. Different organisms would have different labels on the containers. For a human being, the containers could say

| | |
|---|---|
| Child | Date of Extraction |
| Youth | Date of Extraction |
| Young Adult | Date of Extraction |
| Adult | Date of Extraction |
| Middle Age | Date of Extraction |
| Senior | Date of Extraction |

The extracted saliva and or pathogens could be compared to outside samples of saliva from the organism. The saliva at the date of extraction could also be studied. With this type of device, the gum recession and gingival recession issue could be more carefully understood.

One possible use of this invention is to stop what happened to Mary Malone (Typhoid Mary). She was accused of spreading typhoid in 1906-1907. If there were samples of her saliva on file in these containers, then those samples could be checked against the samples found in specific places or in places the person has visited. Did Mary Malone have typhus in her gingival saliva? This tool could be used to keep track and analyze the gum recession or gum pathogen, antigen, DNA and antibody history.

There would need to be clear warnings on this invention about not discontinuing other types of oral health procedures like some brushing, flossing, rinsing, possible appopriate use of mouthwash, other dental techniques, proper nutrition, regular dental visits, and not increasing sugar or sucrose intake.

I claim:

1. A method of preventing gingival recession comprising placing gauze over the tooth or teeth of animals or humans with fingers and wiping up.
2. The gauze containing cold water or attached to cold water.
3. The gauze containing saliva collected from animals or humans.
4. The gauze connected to wax.
5. The gauze containing basic hydroxyl ions.

2. A method for preventing and treating gingival recession comprising pressing the gums with gauze to promote healing and reconnection of the gums with the tooth. The gauze could contain the elements of claim 1.

3. A saliva and pathogen holding device comprising
(a) Piece or pieces of gauze
(b) containers for the extracted saliva and pathogens
(c) labels on containers for age intervals of animal or human life span
